(19) United States
(12) Patent Application Publication
(10) Pub. No.: US 2004/0017158 A1
(43) Pub. Date: Jan. 29, 2004

(54) Smart dimmer switch for maintaining constant luminance in a lighting environment

(75) Inventors: Simon Saw-Teong Ang, Singapore (SG); YiCheng Jin, Kunming (CN)

Correspondence Address: SIMON SAW-TEONG ANG, UBI TECHPARK, 10 UBI CRESCENT, # 02-52, SINGAPORE, SG

(73) Assignee: SVT Technologies Private Limited,, Singapore (SG)

(21) Appl. No.: 10/202,907

(22) Filed: Jul. 26, 2002

(51) Int. Cl. H05B 37/02

(52) U.S. Cl. 315/149; 315/194; 307/117

(57) ABSTRACT

The present invention is directed toward a smart dimmer switch comprises of a power semiconductor switch that automatically changes the luminous level of lamp or group of lamps as the ambient luminous level changes according to an algorithm stored in a microcontroller. The microcontroller accepts an input signal from a light sensor or group of light sensors and adjusts the phase angle of the drive signal to the driver circuit of the power semiconductor switch through an opto-coupler using a software algorithm to allow the luminous output of the lamp or light fixture to be higher or lower than the preset luminous output level, in order to maintain a constant ambient luminous level selected by the users. The software algorithm, together with a non-volatile memory and the microcontroller, allows the desired ambient luminous level to be retained even when the AC supply power is cut off from the smart dimmer switch.

### BACKGROUND OF THE INVENTION

This invention relates to a smart dimmer switch capable of maintaining a constant luminance by adjusting the output intensity of the light bulb(s) (or lamps) or light fixture according to the ambient light level.

Constant luminance is desired in many settings, in particular in areas exposed to outdoor natural light or sunlight. By maintaining a constant ambient luminance level, it enhances the appearance of the lighting environment. It also saves energy cost since the output luminance of the light bulbs (or lamps) reduces with increasing ambient luminance, thus reducing the consumption of electrical energy. Another desired feature by the users is the ability of the switch to retain its setting selected by its user after by cutting off the AC power supply.

A light sensitive dimmer switch circuit is described in U.S. Pat. Nos. 5,789,869 and 6,111,813 by Lo et. al. In these prior arts, a light sensitive dimmer switch circuit for controlling the illumination level of a light as a function of the ambient level surrounding the dimmer switch circuit by selectively controlling an AC power signal provided to the light includes a photocell and a phase control circuit is described. The photocell is responsive to the ambient illumination level and has a conduction state associated therewith. The conduction state changes, in response to the ambient illumination level such that the photocell effectively exhibits either a substantially open circuit or a substantially short circuit. The phase control circuit selectively varies a conduction phase angle associated with the AC power signal which correspondingly causes a variation in the illumination level of the light. The phase control circuit, in response to the photocell, selectively varies such conduction angle and thus the illumination level associated with the light when the photocell exhibits an open circuit and conversely, prohibits the AC power signal from being provided to the light when the photocell exhibits a short circuit. Preferably, the phase control circuit permits the light to illuminate approximately at a full illumination level while the photocell exhibits a short circuit. Thus, the light sensitive dimmer switch circuit controls the light such that a user may operate the same in either an off region, a dimming region, or a full illumination region. The above described prior art describes a dimmer circuit that operates in the full dimming region with the light illuminates approximate between the full illumination level and a minimum illumination level provided that the ambient illumination level is not substantially above the threshold level of the dimmer switch circuit.

The smart dimmer switch described in this invention have additional features not possible in the above described prior arts (U.S. Pat. Nos. 5,789,869 and 6,114,813). These differences are summarized below:

(1) The smart dimmer switch described in this invention automatically adjusts the luminous output of the lamp or light fixture based on the preset desired ambient luminous level via a software algorithm in a microcontroller by varying the phase angle of the drive signal that drives the AC power semiconductor switch through an opto-coupler. It allows the luminous output level of the lamp to be higher or lower than the preset luminous level. The luminous output of the lamp ranges from 0% to 100%. The prior arts do not employ a microcontroller to adjust the phase angle.

(2) The smart dimmer switch described in this invention retains the pre-set ambient luminous level in a non-volatile memory after the AC power supply is switched off. The prior arts do not have this feature.

(3) Remote control scheme, such as infrared, RS232 and wireless, is implemented in the smart dimmer switch described in this invention. No remote control scheme is claimed in the above prior arts.

(4) The smart dimmer switch described in this invention employs a delay response to any changes in ambient light level. This is to eliminate the need to change the luminous output level for a temporary change in ambient light level such as due to a person passing by the smart dimmer switch. The prior arts do not and cannot have this feature.

(5) The smart dimmer switch described in this invention employs different time responses to increment and decrement the luminous output. The smart dimmer switch decreases its luminous output slowly while it increases its luminous output rapidly to prevent a sudden dark out. The prior arts do not and cannot have this feature.

In another prior art by Coveley as described in U.S. Pat. No. 5,586,048, an intelligent wall switch that incorporates a passive infrared sensor and a pressure pulse-wave sensor is described. A microcontroller monitors the sensor signals generated by the infrared sensor and the pressure pulse-wave sensor and calculates a weighted sum of the signal generated by the sensor. If the weighted sum calculated by the microcontroller exceeds a preset threshold the intelligent wall switch generates a signal indicative of human presence. The above described prior art does not make use of light sensing to generate the signals required for lighting control. This prior art also cannot retain its preset luminous values.

In another prior art by Smith as described in U.S. Pat. No. 6,002,340, a smart switch is described to remotely sensing the status(es) of one or more electrically powered target systems and for altering the status(es) of the target systems via various communication channels. This prior art claims several communication protocols, not related to the smart dimmer switch described in this invention.

### SUMMARY OF THE INVENTION

The present invention is directed toward a smart dimmer switch for maintaining a constant luminance by automatically adjusting the light output of light bulbs or lamps according to the ambient light level. It is based on a software algorithm that varies the phase angle of the drive signals to a TRIAC to change the luminous output of the lamp. The current flowing through the power semiconductor switch increases or decreases with the drive signals, thereby increasing or decreasing the luminous output of the lamp or light fixture.

In a preferred embodiment as shown in drawing 1, present invention is directed toward a smart dimmer switch for maintaining a constant luminance by automatically adjusting the light output of a lamp (or a parallel connection of a group of lamps) or a light fixture according to the preset ambient luminous level. In one implementation of a smart dimmer switch circuit comprising of an AC input terminal (L′) and an AC output terminal (N), the said AC input terminal L′ is connected to one terminal of an inductor (L1), the other terminal of the said inductor L1 is coupled to the input terminal of a TRIAC (T1), the output terminal of said TRIAC T1 is coupled to one terminal of a lamp (or a group of parallel combination of lamps) or light fixture (B1), the other terminal of said lamp B1 is connected to the AC output terminal N; the control terminal of said TRIAC T1 is connected to one terminal of a DIAC in an opto-coupled (OP1), the other terminal of said DIAC is connected to one terminal of a resistor (R1), the other terminal of said resistor R1 is connected to the output terminal of said TRIAC T1; the output terminal of said TRIAC T1 is connected to a capacitor (C1), the other terminal of said capacitor C1 is connected to the said AC input terminal L′, the cathode terminal of a photodiode in said opto-coupler OP1 is connected to the collector of a transistor (Q1), the anode terminal of said photodiode is connected to a pull-up resistor (R2), the other terminal of said pull-up resistor R2 is connected to the low-voltage power supply Vcc1; the base of said transistor Q1 is connected to a bias network consisting of resistors R3, R4, R5, and capacitor C2. The base terminal of said transistor Q1 is connected to one terminal of said resistors R5, the other terminal of said resistor R5 is connected to one terminal of said resistors R3 and R4 and said capacitor C2, the other terminal of said resistor R3 is connected to common, the other terminal of said capacitor C2 is connected to common, the other terminal of R4 is connected to said low-voltage power supply voltage Vcc1; the emitter terminal of said transistor Q1 is connected to one terminal (GP1) of a microcontroller (MP1) comprising of eight terminals labeled as GP0, GP1, GP2, GP3, GP4, GP5, and two power supply terminals labeled as Vss and Vcc; the Vcc terminal of said microcontroller MP1 is coupled to said low-voltage supply terminal Vcc1; the Vss terminal of said microcontroller MP1 is connected to one terminal of a capacitor (C4), one terminal of a resistor (R6), and one terminal of a capacitor (C5), the other terminal of said capacitor C4 is connected to said low-voltage supply terminal Vcc1, the other terminal of said resistor R6 is connected to one terminal of two light sensitive resistors (Rs1 and Rs2), the other terminal of said capacitor C5 is connected to one terminal of said light sensitive resistors Rs1 and Rs2; the input terminal, GPO of said microcontroller MP1 is connected to the other terminal of said light sensitive resistors Rs1 and Rs2 that detect the ambient luminance or light level; the other terminals of said light sensitive resistors Rs1 and Rs2 are connected to said low-power supply terminal Vcc1; the second input terminal, GP4, of said microcontroller MP1 is connected to one terminal of a bounce switch (K1) and one terminal of a pull-up resistor (R7), the other terminal of said resistor R7 is connected to said low-voltage supply terminal Vcc1; the other terminal of said bounce switch K1 is connected to the common ground; the third input terminal, GP5, of said microcontroller MP1 is connected to a bounce switch (K2) and one terminal of a pull-up resistor (R8), the other terminal of said resistor R8 is connected to said low-voltage supply terminal Vcc1, the other terminal of said bounce switch K2 is connected to the common ground; the second terminal, GP4, and the third input terminals, GP5, of said microcontroller MP1 thus determine the output light intensity of the light bulbs or lamps through a software algorithm, the input terminal GP2 of said microcontroller MP1 is connected to the collector terminal of a photo-transistor in an opto-coupler OP2 and to one terminal of a resistor R9, the other terminal of said resistor R9 is connected to said low-voltage power supply terminal Vcc1, the emitter terminal of said photo-transistor is connected to the common ground, the anode terminal of the photodiode in said opto-coupler OP2 is connected to the positive terminal of a diode bridge DB1, the cathode terminal of the photodiode in said opto-coupler OP2 is connected to the negative terminal of said diode bridge DB1, the input terminals of said diode bridge are connected to the said AC input terminal L′ and said AC output N terminals, the low-voltage supply terminal Vcc1 is connected to one terminal of a capacitor C6 and the output terminal of a voltage regulator IC1 comprising of an output terminal, a common terminal, and an input terminal, the other terminal of said capacitor C6 is connected to the common, the common terminal of said voltage regulator IC1 is connected to the common, the input terminal of said voltage regulator IC1 is connected to one terminal of a capacitor C7, one terminal of capacitor C8, and one terminal of a zener diode Z1, the other terminals of said capacitors C7, C8 and zener diode Z1 are connected to the common, the input terminal of the voltage regulator IC1 is also connected to the positive output terminal of a diode bridge DB2 consisting of four rectifiers, the negative output terminal of said diode bridge DB2 is connected to the common, one input of said diode bridge DB2 is connected to the said AC output terminal N, the other input terminal of said diode bridge DB2 is connected to one terminal of a capacitor C9, one terminal of a resistor R10, the other terminals of said resistor R10 and said capacitor C9 are connected to one terminal of a resistor R11, the other terminal of said resistor R11 is connected to the said AC input terminal L′, the said AC input terminal L′ is connected to one terminal of a fuse F1, the other terminal of said fuse F1 is connected to a switch SW. The other terminal of said switch SW is connected to the AC input terminal L.

While the embodiments, applications and advantages of the present invention have been depicted and described, there are many more embodiments, applications, and advantages possible without deviating from the spirit of the inventive concepts described herein. The invention should only be restricted in accordance with the claims appended hereto and is not restricted by the preferred embodiments, specifications or drawings.

We claim:

1. A smart dimmer switch as shown in the block diagram of drawing 2 comprising:
An AC input terminal (L) coupled to the input of an alternating current (AC) power semiconductor switch (TRIAC) through an inductor;
A lamp (or a parallel connection of a group of lamps) or light fixture assembly comprises of two terminals, one terminal coupled to one terminal of said alternating-current power semiconductor switch, the other terminal coupled to the AC output terminal (N);
An AC power semiconductor switch (TRIAC) comprises of an input terminal, an output terminal, and a control terminal, the input terminal of said power semiconductor switch coupled to the AC input terminal (L) through an inductor, the output terminal of said power semiconductor switch coupled to one terminal of said light bulbs (or lamps), the control terminal coupled to a microcontroller-based phase control driver circuit;
A microcontroller-based phase controlled driver circuit consisting of a drive transistor with its emitter terminal connected to an output control terminal of a microcontroller, the collector terminal connected to the input terminal of an opto-coupler, the base terminal connected to a low-voltage power supply circuit through a resistive bias network, the output terminal of said opto-coupler connected to the control terminal of said AC power semiconductor switch;
A microcontroller comprises of at least four input terminals, an output control terminal, and power supply terminals; the first input terminal coupled to a light sensor or a group of several sensors that detect the ambient luminance or light level through an analog-to-digital converter interface to the microcontroller; the second input terminal coupled to a bounce switch that decrements the output light level; the third input terminal coupled to a bounce switch that increments the output light level; the inputs at the second and the third input terminals thus determine the phase angle of the output control signal of said microcontroller through a software algorithm, the fourth terminal detects the zero crossing of the AC power supply to provide the proper timing, even in a polluted AC power supply, for the drive signal to the AC power semiconductor switch (TRIAC);
A software algorithm automatically adjusts the phase angle of the drive signal at the output control terminal of said microcontroller to the drive stage that drives said power semiconductor switch to maintain a constant luminous level of the lamp or lighting fixture by adjusting the magnitude of the current flowing through said power semiconductor switch and said lamp or light fixture, the constant luminous level is determined by both said bounce switches that increment and decrement the desired luminous level of said lamp or light fixture;
The software algorithm allows the luminous output of the lamp or light fixture to be higher or lower than the preset luminous level according to the ambient light level by adjusting the output control signal of said microcontroller that drives said driver circuit of said power semiconductor switch through phase angle variations. The luminous output of the lamp ranges from 0% to 100%. A delay in decreasing the luminous light output is built into the software algorithm to prevent sudden darkening of the lamp due to a sudden change in the ambient light level. The software algorithm allows the luminous output of said lamp or light fixture to increase rapidly should the ambient luminous level falls rapidly.
The software algorithm further allows a delay in the change of the phase angle of the output control signal of said microcontroller that drives said power semiconductor switch for a temporary change in ambient luminous level such as when a person is passing by the smart dimmer switch.

2. A smart dimmer switch as claimed in 1, additionally comprising:
Upon switching off, the algorithm together with a nonvolatile memory and said microcontroller retains the previously set luminous level when the smart dimmer switch is switched on again.

3. A smart dimmer switch as claimed in 1, additionally comprising:
A mean of controlling the luminous level of said lamp (or a parallel connection of a group of lamps) or light fixture remotely via infrared beam.
An infrared transmit circuit consists of an encoder circuit that has two bounce switches and transmits the infrared signals corresponding to the increment or decrement of the luminous level via an infrared diode.
The bounce switches as claimed in 1 are replaced by a receiver circuit consisting of a decoder that receives an infrared beam and decodes the infrared signals transmitted by the infrared encoder circuit to change the two inputs of said microcontroller.

4. A smart dimmer switch as claimed in 1, additionally comprising:
A mean of controlling the luminous level of the lamps or light fixture remotely by transmitting the controlled signal through computer interface such as RS232.
The bounce switches as claimed in 1 are replaced by a receiver circuit consisting of a decoder that receives a controlled signal through computer interface and decodes the “increment” and “decrement” signals transmitted to change the phase angles of the output control signals of said microcontroller that drive the AC power semiconductor switch or TRIAC.

5. A smart dimmer switch as claimed in 1 and shown in drawing 3, additionally comprising:
A mean of controlling the luminous level of the lamps or light fixture remotely by transmitting the controlled signal in wireless form.
A wireless circuit consists of an encoder circuit that has two bounce switches and transmits the wireless signals corresponding to the increment or decrement of the luminous level.
The bounce switches as claimed in 1 are replaced by a receiver circuit consisting of a decoder that receives a wireless signal and decodes the “increment” and “decrement” signals transmitted to change the phase angles of the output control signals of said microcontroller that drive the AC power semiconductor switch or TRIAC.
